(19) United States
(12) Patent Application Publication
(10) Pub. No.: US 2006/0050683 A1
(43) Pub. Date: Mar. 9, 2006

(54) Prioritization of service requests received at a session initiation protocol (SIP) server

(75) Inventors: Stephen B. Wall, Reston, VA (US); Ahmad Bencheikh, Fairfax Station, VA (US)

Correspondence Address: CROWELL & MORING LLP;INTELLECTUAL PROPERTY GROUP, P.O. BOX 14300, WASHINGTON, DC, 20044-4300, US

(73) Assignee: NEXTEL COMMUNICATIONS, INC., Reston, VA (US)

(21) Appl. No.: 11/093,978

(22) Filed: Mar. 30, 2005

Related U.S. Application Data
(60) Provisional application No. 60/608,127, filed on Sep. 9, 2004.

(51) Int. Cl. H04L 12/66

(52) U.S. Cl. 370/352

(57) ABSTRACT

A system and method for prioritizing service requests to a SIP server is disclosed. In accordance with a system of the present invention, a SIP server is provided. The SIP server includes a processor for processing service requests to the SIP server and a database. The database includes data related to a first source IP address for a first service request to the processor and a second source IP address for a second service request to the processor. The processor determines a priority order for processing of the first service request and the second service request by comparing the first source IP address and the second source IP address to the data in the database. In accordance with a method of the present invention, a method for processing requests for services at a SIP server is provided. The method includes the steps of receiving a first request having a first source IP address for a first service at the SIP server, receiving a second request having a second source IP address for a second service at the SIP server, and determining a priority order for processing of the first request and the second request by considering the first source IP address and the second source IP address.

### FIELD OF THE INVENTION

The present invention relates generally to the field of telecommunications, and in particular, to prioritization of service requests to a session initiation protocol (SIP) server.

### BACKGROUND OF THE INVENTION

It is generally known how to improve Quality of Service (QoS) for communications in a communications system. For example, various levels of priority can be assigned to Internet Protocol (IP) packets associated with a particular communication when they are routed between routers and switches in an IP network. The packets are forwarded by the routers and switches in accordance with the assigned priority. Higher priority packets are routed before lower priority packets. However, this prioritization scheme is only directed to the routing of IP packets in a communications system.

It is also generally known to assign various levels of priority for different processes that may be performed by a processor. For example, one process performed by a processor may be assigned a higher priority than another process. The higher priority process is performed before the lower priority process. However, this prioritization scheme is based on prioritizing processes performed by a processor and utilizes a technique for assigning various relative priorities to the processes themselves. For example, a higher priority may be assigned to a data calculation process than is assigned to a data back-up process. These schemes, while well understood, only provide priority in the allocation of processor resources between processes and are independent of the source of the processing requests, i.e., the user or network element that has a processing requirement. These schemes may be referred to as process priority schemes.

Currently, the session initiation protocol (SIP) standard is being developed. SIP is a text-based protocol, similar to HTTP and SMTP, for initiating interactive communication sessions between users. Such sessions include voice, video, chat, interactive games, and virtual reality. Thus, SIP will provide for multiple communication services between users. For more information regarding SIP, the interested reader should refer to http://www.ietf.org/html.charters/sip-charter.html, the entire disclosure of which is herein expressly incorporated by reference.

There is a need to prioritize service requests to a SIP server. As discussed above, SIP is a standard to support multi-media applications and any SIP server on a service provider network may have to prioritize between millions of both direct requests from individual subscribers and requests from network devices running network applications. Because of the expected future high demand for SIP services, there may be contention when attempting to respond to these service requests by a SIP server and it would be desirable to provide a method to prioritize these requests. For example, in a contention for services between a Voice over IP (VoIP) telephone call directly from a user and a request by a network server running an application for relatively-routine presence information for a network application, it would be desirable to assign a higher priority to the VoIP service request from the user than the presence information request from the network application server.

There are other numerous possible circumstances where it would be desirable for the SIP server to prioritize one SIP service request over others. In an additional example, one service provider's SIP server may receive requests from another service provider's network. The service provider may desire to prioritize SIP requests from the service provider's network elements, i.e., softswitches, SIP proxies, etc., over requests from another service provider's network elements. This would prevent service requests from non-subscriber devices from degrading the performance of the service provider's SIP server in providing subscriber services.

Currently, requirements are being defined for resource priority mechanisms for SIP. For example, Request For Comments (RFC) 3487—Requirements for Resource Priority Mechanisms for the Session Initiation Protocol (SIP)—was issued in February 2003. However, this requirements document only describes priority requirements rather than possible existing or new protocol features for meeting these requirements. Therefore, there is a need to consider solutions for prioritizing service requests to a SIP server.

Whereas a SIP request message can include a header which may indicate a priority of the request, this priority header field indicates the urgency of the request as perceived by the sender. For example, the header field can have the values “non-urgent”, “normal”, “urgent”, and “emergency”. However, this priority does not reflect a priority for processing by the SIP server that is established by a service provider. Rather, the priority only reflects the sender's perception of the priority of the request without considering other requests that may be received by the SIP server.

Therefore, it would be desirable to provide a system and method for prioritizing service requests to a SIP server for efficient utilization of the SIP server. In accordance with the present invention, priority is assigned to the SIP server service request based on the source IP address of the request.

### SUMMARY OF THE INVENTION

In accordance with a system of the present invention, a SIP server is provided. The SIP server includes a processor for processing service requests to the SIP server and a database. The database includes data related to a first source IP address for a first service request to the processor and a second source IP address for a second service request to the processor. The processor determines a priority order for processing of the first service request and the second service request by comparing the first source IP address and the second source IP address to the data in the database.

In accordance with a method of the present invention, a method for processing requests for services at a SIP server is provided. The method includes the steps of receiving a first request having a first source IP address for a first service at the SIP server, receiving a second request having a second source IP address for a second service at the SIP server, and determining a priority order for processing of the first request and the second request by considering the first source IP address and the second source IP address.

### BRIEF DESCRIPTION OF THE DRAWINGS

FIG. 1 illustrates a SIP server in accordance with the principles of the present invention;

FIG. 2 illustrates an exemplary system in which a user accesses a SIP server in accordance with the principles of the present invention;

FIG. 3 illustrates an exemplary system in which network elements access the SIP server in accordance with the principles of the present invention;

FIG. 4 illustrates an exemplary system in which a parlay server accesses the SIP server in accordance with the principles of the present invention; and

FIG. 5 illustrates an exemplary system in which network elements and a parlay server access a SIP server in accordance with the principles of the present invention.

### DETAILED DESCRIPTION OF THE EXEMPLARY EMBODIMENTS

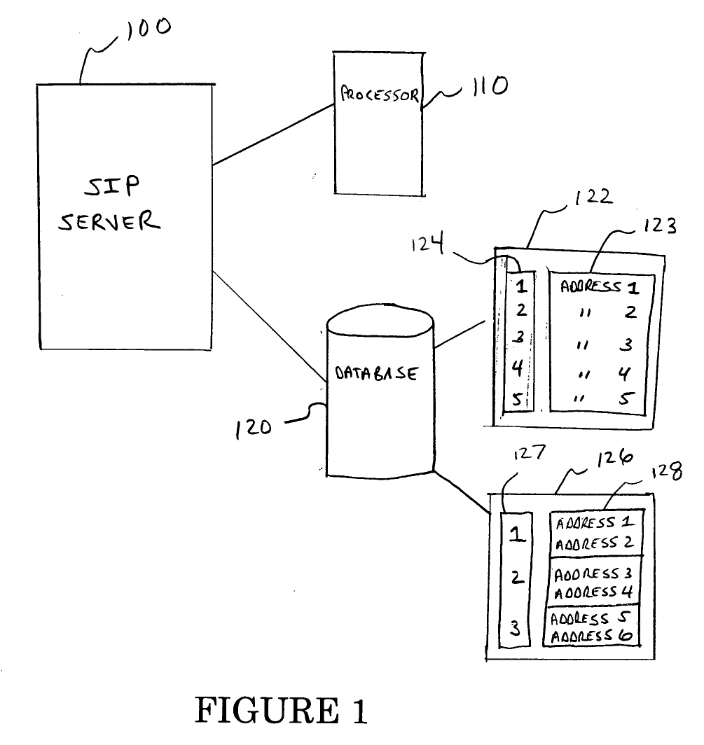

FIG. 1 illustrates an exemplary SIP server 100 that includes a processor 110 and a database 120 in accordance with the principles of the present invention. SIP server 100 receives and processes requests for services from a variety of sources. As defined in SIP standards document Request For Comments (RFC) 3261, a SIP server is a network element that receives requests in order to service them and sends back responses to those requests. Examples of servers are proxies, user agent servers, redirect servers, and registrars.

Exemplary service requests are associated with services such as voice, chat, interactive games, and virtual reality. Exemplary sources for these requests include individual users using telephone handsets or personal computers, network servers providing network applications, and parlay servers providing parlay mediated applications.

SIP server 100 processes requests for services by utilizing processor 110 and database 120. Database 120 is utilized to prioritize requests for services based on the source IP address of the request. As such, database 120 includes data that is related to the source IP addresses of the incoming requests. This data can include any of a variety of different types of information that may be utilized to prioritize the request based on the source IP address of the request. For example, the data can be a listing of source IP addresses with a relative processing priority assigned to each source IP address. Table 122 of database 120, as illustrated in FIG. 1, shows a listing of source IP addresses 123 and a relative priority 124 that is assigned to each.

Alternatively, table 126 of database 120 illustrates that priorities 127 can be assigned to different sets 128 of source IP addresses, with each set being directed to a different category of service requestor. In this example, set 1 can be a listing of all source IP addresses that are associated with subscriber telephone handsets, set 2 can be addresses that are associated with network application server requests, and set 3 from parlay mediated application server requests. In this example, set 1 may be assigned the highest priority for processing and set 3 the lowest. Thus, a request associated with a source IP address included in set 1 would be processed before a request associated with a source IP address included in set 3. By grouping source IP addresses in priority sets, prioritizing the requests may be accomplished more efficiently because it would not be required to always compare one request versus another to determine which request to process first. For example, it could be programmed into processor 110 that any request from a set 1 source IP address must be processed immediately. Thus, set 1 requests, without doing any comparison to other requests, are immediately processed by the processor.

However, regardless of how the source IP addresses are categorized and/or prioritized, database 120 contains data related to the source IP addresses of requests to the SIP server that provides for prioritizing the requests based on the source IP address of the request. One skilled in the art can contemplate various schemes for organizing the data in database 120 related to the source IP addresses for requests to the SIP server and the present invention is not limited to any particular methodology for prioritizing the source IP addresses. As discussed above, service requests to the SIP server are prioritized by the IP address of the device that is making the request, i.e., the source device. As will be discussed below, the source device can be, for example, an IP telephony handset, computer, network application server, or parlay mediated application server.

As is known, the source IP address is the identifier for a computer or device on a TCP/IP network. The format of the IP address is a 32-bit numeric address written as four numbers separated by periods. Each number can be in a range between 0-255. For example, 168.212.226.204 could be an IP address. However, the present invention is not limited to any particular format for the source IP address or to any particular format for identifying the source device. The present invention can be practiced by utilizing any scheme to designate the device that is making the request to the SIP server. For example, the source device could be identified by using the “From” field in the SIP service request message header or an alias for the IP address. All that is required is that the source device be identified so that its request can be appropriately prioritized.

The present invention is not limited to prioritizing between competing service requests that are received at the SIP server simultaneously, or near simultaneously. Whereas the present invention can certainly be utilized to prioritize between simultaneously received service requests, the present invention can also be practiced in any circumstance where it is desirable to prioritize service requests to a SIP server. For example, if service requests are received and then placed in a queue for future processing, the present invention can prioritize these queued service requests. The present invention has utility in any application where it may be beneficial to prioritize a service request to a SIP server, whether the service requests are received simultaneously, stored in a queue, prioritized relative to each other, or prioritized based on a categorization of the service requestor.

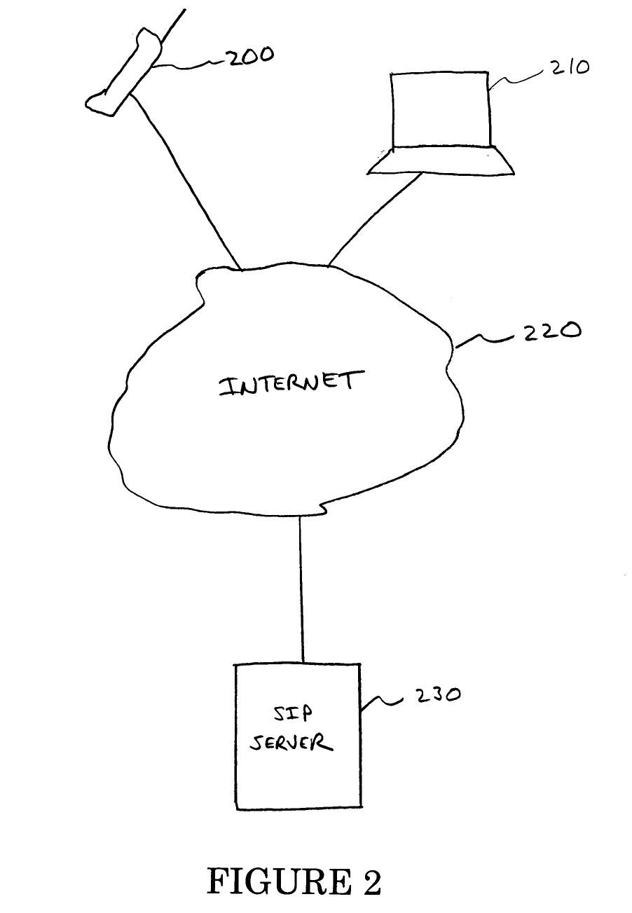

Particular exemplary service requests to a SIP server that can be prioritized in accordance with the principles of the present invention are illustrated in FIGS. 2-5. FIG. 2 illustrates a service request where a user, by utilizing either telephone handset 200 or computer 210, is making a Voice over Internet Protocol (VoIP) telephone call through the Internet 220, as is well-known. The SIP server 230 is utilized in the VoIP communication and receives a request from the user in association with the call. In this circumstance, the request is received at the SIP server and associated with the service request is the source IP address of either the user's telephone handset 200 or computer 210, depending upon which device is being utilized by the user to make the VoIP call.

In accordance with the principles of the present invention, the SIP server 230 receives the source IP address of the user device that is making the VoIP call. As discussed earlier in this specification, SIP server 230 consults a database to determine a priority to be assigned to the VoIP service request based on the source IP address of the request. The request is processed by the SIP server 230 in accordance with the priority that is assigned to the request. In this circumstance, whereas no particular relative priority is required to be assigned to this request, it would most-likely receive a high priority, and possibly the highest priority relative to other requesters, due to the QoS required for VoIP communications.

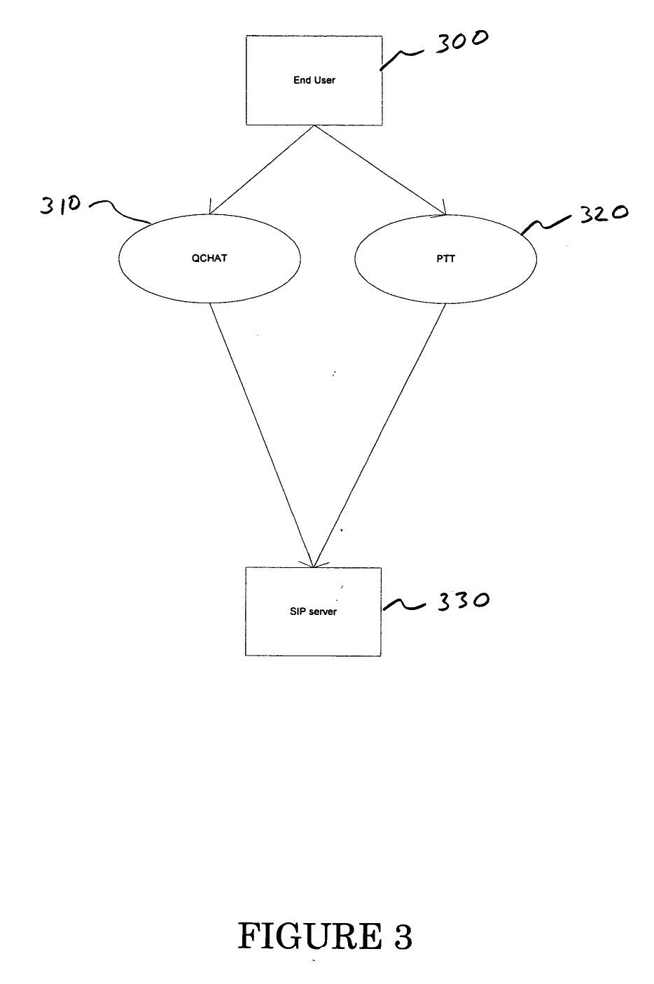

FIG. 3 illustrates an exemplary service request from a network server running a network application. Here, the end user 300 is utilizing a network application, which in this exemplary communication is either Qualcomm Inc.'s dispatch communication application QChat™ 310 or Nextel Communications, Inc.'s dispatch communication application Push-to-Talk (PTT) 320. In this exemplary service request, servers running these applications may access SIP server 330 for requests related to, for example, presence and location information for a called party.

In this exemplary service request, the request is received at the SIP server 330 and associated with the service request is the source IP address of the network equipment, e.g., the server, that is running the QChat™ or PTT application. Therefore, in accordance with the principles of the present invention, SIP server 330 consults a database to determine a priority to be assigned to the network server's service request based on the source IP address of the network device. As described previously, the request is processed by the SIP server 330 in accordance with the priority that is assigned to the request. Again, whereas no particular relative priority is required to be assigned to this request, it would most-likely receive a priority that is less than the VoIP request discussed above.

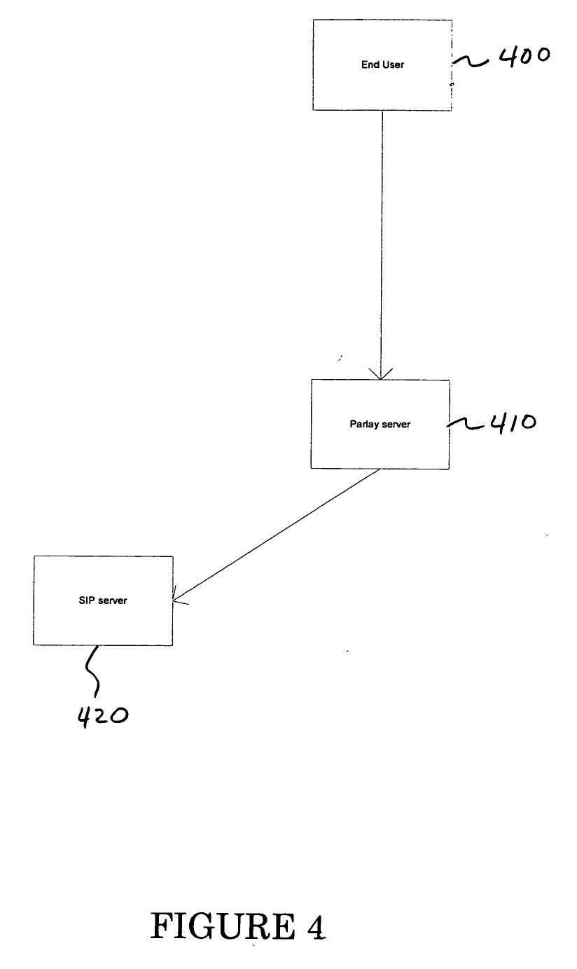

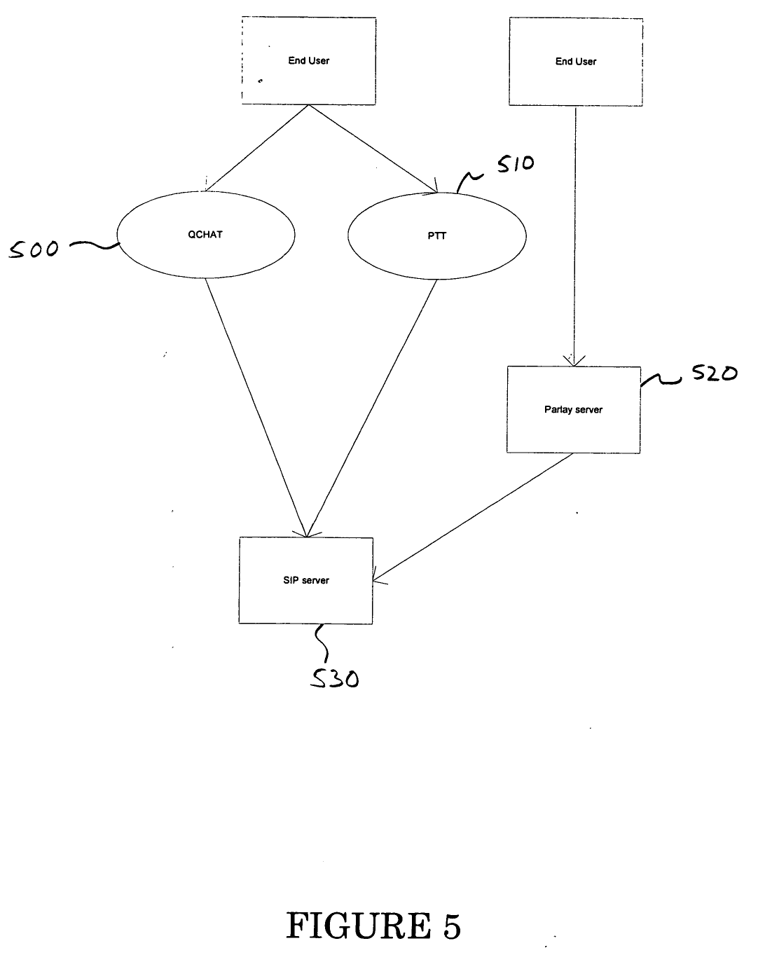

FIGS. 4 and 5 illustrate another exemplary request and a situation where two particular competing requests are received at a SIP server, respectively. As can be seen in FIG. 4, an exemplary request is illustrated in which an end user 400 is using a parlay mediated application which is housed on a parlay server 410. As is known, parlay application programming interfaces (APIs) are designed to enable creation of applications. A parlay “application” refers to software that invokes a service and the parlay server implements the service. Thus, in this example, the parlay application resides outside of a telephony application, e.g., the QChat™ or PTT applications, however, it can still access the same SIP server that is accessed by these applications. For more information regarding the parlay application program interface (API), the interested reader should refer to http://www.parlay.org/specs/index.asp, the entire disclosure of which is herein expressly incorporated by reference.

In this exemplary service request, the request is received at the SIP server 420 and associated with the service request is the source IP address of the parlay server that is running the parlay mediated application. As previously described, in accordance with the principles of the present invention, SIP server 420 consults a database to determine a priority to be assigned to the parlay mediated application service request based on the source IP address of the parlay server.

FIG. 5 illustrates the situation where the telephony applications 500 and 510 and the parlay mediated application on parlay server 520 request SIP services from SIP server 530. In this circumstance, it is possible to have contention for these services. To mitigate this contention, as described previously, QoS prioritization could be implemented within the SIP server by prioritizing the service requests based on their source IP address. This would give a carrier the ability, for example, to set the QoS for the telephony applications' request for services to the SIP server higher than the QoS for parlay mediated application requests. The end result would be scalable SIP server access without service disruption.

In the present invention, the parlay application server and the network application server can either reside on the same service provider network or on different service provider networks. The parlay server is not limited to residing on any particular network. As discussed above, the parlay server merely provides an application to a service provider network by utilizing the well-known Parlay/OSA application programming interface. For example, a developer can build a Parlay/OSA application that sets up a conference call when a group of people are free, while not restricting that application to an IS-41 network, or a GSM network, or a SIP-based network. Additionally, the present invention can be utilized for prioritizing between service requests received from separate service provider networks, regardless of whether either of the requests is coming from a parlay application server.

Additionally, whereas the exemplary embodiments of the present invention prioritize service requests to a SIP server, the present invention is not limited to a SIP server. The present invention can be practiced in prioritizing a service request to any type of server based on the source of the request.

While the present invention has been described in connection with various embodiments, it will be understood that the invention is capable of further modifications. This application is intended to cover any variations, uses or adaptation of the invention following, in general, the principles of the invention, and including such departures from the present disclosure within the known and customary practice within the art to which the invention pertains.

What is claimed is:

1. A method for processing requests for services at a session initiation protocol (SIP) server, comprising the steps of:
receiving a first request having a first source Internet Protocol (IP) address for a first service at the SIP server;
receiving a second request having a second source IP address for a second service at the SIP server; and
determining a priority order for processing of the first request and the second request by considering the first source IP address and the second source IP address.

2. The method of claim 1 further comprising the steps of:
processing the first request and the second request in the determined priority order.

3. The method of claim 1 wherein the first source IP address is associated with a user device and the second source IP address is associated with a network device and wherein the first request is determined to have a higher priority order for processing by the SIP server than the second request.

4. The method of claim 3 wherein the user device is a telephone handset.

5. The method of claim 3 wherein the user device is a personal computer.

6. The method of claim 3 wherein the first request is associated with a Voice over Internet Protocol (VoIP) telephone call.

7. The method of claim 1 wherein the step of determining a priority order for processing of the first request and the second request includes the step of comparing the first and second source IP addresses against a database of stored source IP addresses.

8. The method of claim 7 wherein a service provider determines a relative priority between the stored IP addresses in the database.

9. The method of claim 1 wherein the first request and the second request are received simultaneously at the SIP server.

10. The method of claim 1 wherein the first request and the second request are stored in a queue in the SIP server.

11. The method of claim 1 wherein the first source IP address is associated with a network application server and the second source IP address is associated with a parlay application server and wherein the first request is determined to have a higher priority order for processing by the SIP server than the second request

12. The method of claim 1 wherein the first request is associated with a CDMA telephony application.

13. The method of claim 1 wherein the first request is associated with a push-to-talk telephony application.

14. The method of claim 1 wherein the first source IP address is associated with a first priority set of IP addresses stored in a database and the second source IP address is associated with a second priority set of IP addresses stored in the database.

15. The method of claim 1 wherein the first request is received at the SIP server at a first time and the second request is received at the SIP server at a second time and wherein the first time is prior to the second time.

16. The method of claim 15 wherein the second request is determined to have a higher priority order for processing by the SIP server than the first request.

17. A session initiation protocol (SIP) server, comprising:
a processor for processing service requests to the SIP server; and
a database, wherein the database includes data related to a first source Internet Protocol (IP) address for a first service request to the processor and a second source Internet Protocol (IP) address for a second service request to the processor;
wherein the processor determines a priority order for processing of the first service request and the second service request by comparing the first source IP address and the second source IP address to the data in the database.

18. The SIP server of claim 17 wherein the first source IP address is associated with a user device and the second source IP address is associated with a network application server.

19. The SIP server of claim 17 wherein the first source IP address is associated with a network application server and the second source IP address is associated with a parlay application server.

20. The SIP server of claim 19 wherein the network application server and the parlay application server both reside on a same service provider network.

21. The SIP server of claim 19 wherein the network application server resides on a first service provider network and the parlay application server resides on a second service provider network.

22. The SIP server of claim 17 wherein the first source IP address is associated with a first service provider network and the second source IP address is associated with a second service provider network.

23. A method for prioritizing service requests at a session initiation protocol (SIP) server, comprising the steps of:
receiving a first service request at the SIP server from a network application server;
receiving a second service request at the SIP server from a parlay application server; and
granting priority to the first service request over the second service request.

24. The method of claim 23 wherein the step of granting priority to the first service request over the second service request includes the step of comparing the source IP address of the network server to the source IP address of the parlay server.

25. The method of claim 23 wherein the network application server and the parlay application server both reside on a same service provider network.
